(19) United States
(12) Patent Application Publication
(10) Pub. No.: US 2007/0024553 A1
(43) Pub. Date: Feb. 1, 2007

(54) LIQUID CRYSTAL DISPLAY DEVICE, DISPLAY CONTROL METHOD AND DISPLAY CONTROL APPARATUS

(76) Inventors: Shigesumi ARAKI, Ishikawa-gun (JP); Tetsuya KOJIMA, Ishikawa-gun (JP); Kenji NAKAO, Kanazawa-shi (JP); Kazuhiro NISHIYAMA, Kanazawa-shi (JP); Mitsutaka OKITA, Hakusan-shi (JP); Masahiko TAKEOKA, Yamatokoriyama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/460,414

(22) Filed: Jul. 27, 2006

(30) Foreign Application Priority Data
Jul. 28, 2005 (JP) 2005-218575
Oct. 7, 2005 (JP) 2005-294627
Oct. 7, 2005 (JP) 2005-294628

(51) Int. Cl. G09G 3/36

(52) U.S. Cl. 345/87

(57) ABSTRACT

A liquid crystal display device comprises an OCB-mode liquid crystal display panel including a liquid crystal layer in which the alignment state of liquid crystal molecules is transitioned in advance from a splay alignment to a bend alignment, and a display control section which applies a liquid crystal drive voltage to the liquid crystal layer according to a video signal. The display control section is configured to detect the application environment of the liquid crystal display panel and determine a minimum value of the liquid crystal drive voltage based on a phase-transition threshold voltage which causes energy of the splay alignment and energy of the bend alignment to be balanced with each other in the detected application environment.

### CROSS-REFERENCE TO RELATED APPLICATIONS

This application is based upon and claims the benefit of priority from prior Japanese Patent Applications No. 2005-218575, filed Jul. 28, 2005; No. 2005-294627, filed Oct. 7, 2005; and No. 2005-294628, filed Oct. 7, 2005, the entire contents of all of which are incorporated herein by reference.

### BACKGROUND OF THE INVENTION

1. Field of the Invention

This invention relates to a liquid crystal display device, display control method and display control apparatus which maintain the alignment state of liquid crystal molecules suited to display operation in an optically compensated bend (OCB) mode, for example.

2. Description of the Related Art

Recently, in the field of liquid crystal television receivers and mobile telephones, much attention has been given to a liquid crystal display panel of the OCB mode having a high-speed liquid crystal response characteristic required for moving picture display.

Generally, a liquid crystal display panel of the OCB mode has a structure which includes an array substrate having a plurality of pixel electrodes covered with an alignment film, a counter substrate having a common electrode covered with an alignment film, and a liquid crystal layer held between the array substrate and the counter substrate in contact with the alignment films. Further, it includes a pair of polarizers respectively attached to the array substrate and counter substrate with retardation films (optical phase compensation films) for compensating the phase difference disposed therebetween. With the above liquid crystal display panel, a wide viewing angle can be obtained by optical compensation attained by use of a combination of the bend alignment of liquid crystal molecules and the optical phase compensation films.

In the array substrate, the pixel electrodes are arrayed in a matrix. In the counter substrate, the common electrode is arranged to face the pixel electrodes. The pixel electrode and common electrode configure a liquid crystal pixel in association with a pixel region of the liquid crystal layer which is located between the above electrodes. Further, the pixel electrode and common electrode control the alignment state of the liquid crystal molecules in the pixel region in accordance with an electric field corresponding to a liquid crystal drive voltage applied between the pixel electrode and the common electrode. When display operation is performed by use of the liquid crystal display panel, a digital video signal for all the liquid crystal pixels is converted into analog pixel voltages by use of a plurality of reference gradation voltages, for example, and respectively output to the liquid crystal pixels (for example, refer to Jpn. Pat. Appln. KOKAI Publication No. 2003-228332). The pixel voltage is a voltage applied to a pixel electrode with the potential of the common electrode used as a reference and the polarity thereof is periodically inverted with respect to the potential of the common electrode to prevent deterioration of the liquid crystal display panel due to uneven distribution of the liquid crystal molecules.

In the liquid crystal display panel of the OCB mode, as shown in FIG. 18, the alignment state of liquid crystal molecules is changed in advance from a splay alignment to a bend alignment by phase transition driving performed as an initialization process immediately after supply of power and the display operation is performed after the phase transition driving. However, reverse transition from the bend alignment to the splay alignment tends to occur if a voltage-non-applied state, or a voltage-applied state of a voltage not greater than a level at which energy of the splay alignment is balanced with energy of the bend alignment, continues for a long time.

As a measure for preventing the above reverse transition, black insertion driving is known (for example, refer to Jpn. Pat. Appln. Publication No. 2003-295156). The black insertion driving is a dynamic bend system for periodically performing black insertion writing and video signal writing. In the black insertion writing, a reverse-transition preventing black-display voltage which does not correspond to a video signal is applied to the liquid crystal electrode as a pixel voltage. In the video signal writing, a voltage corresponding to the video signal is applied to the liquid crystal electrode as the pixel voltage. With the dynamic bend system, all the rows of liquid crystal pixels should be driven quickly for the black insertion writing and for the video signal writing. Thus, it is difficult to apply the dynamic bend system to a large-sized liquid crystal display panel of a large size. For example, in the case of double-speed black insertion driving, vertical scanning is carried out twice for each frame period to achieve the black insertion writing and the video signal writing. When the black insertion driving is required for a liquid crystal display panel with a diagonal of, for example, 32 inches, existing driver ICs are not usable in the black insertion driving.

The brightness of a liquid crystal display panel is reduced by periodical blinking of a backlight unit which illuminates the panel. However, if the above dimming control is performed, a black belt-like image which moves from the upper end side to the lower end side may appear on the liquid crystal display panel in some cases due to a relationship between the black insertion period from the black insertion writing to the video signal writing and the blinking cycle of the backlight unit. In order to cope with this problem on the backlight unit side, it is necessary to turn on and off the backlight unit at a high frequency of approximately 4 kHz which does not have an influence on the black insertion driving. If the backlight unit is made of an LED light source, it becomes possible to turn on and off the backlight unit at such a high frequency, but it is necessary to accept an increase in the manufacturing cost and a lowering in the efficiency. On the other hand, if the backlight unit is made of a cold-cathode fluorescent tube operable at a frequency lower than approximately 900 Hz, it is difficult to turn on and off the cold-cathode fluorescent tube at a high frequency exceeding the above frequency.

The reverse transition to the splay alignment can be prevented not only in the dynamic bend system, but also in a static bend system, for example. In the static bend system, instead of using the reverse-transition preventing black-display voltage, the liquid crystal drive voltage is maintained over a phase-transition threshold voltage Vc which causes energy of the splay alignment and energy of the bend alignment to be balanced with each other. In this case, the transmittance of a pixel in white display becomes less than 100%, but the power consumption can be reduced since periodic application of the reverse-transition preventing black-display voltage, which causes transition of the pixel voltage, is not required.

However, in the conventional liquid crystal display panel utilizing the static bend system, reverse transition may occur in some cases due to a variation in the application environment such as panel temperature and drive frequency.

### BRIEF SUMMARY OF THE INVENTION

An object of this invention is to provide a liquid crystal display device, display control method and display control apparatus which can prevent occurrence of reverse transition of liquid crystal molecules caused by a variation in the application environment.

According to a first aspect of this invention, there is provided a liquid crystal display device comprising an OCB-mode liquid crystal display panel including a liquid crystal layer in which liquid crystal molecules are aligned in a bend alignment, and a display control section which applies a liquid crystal drive voltage to the liquid crystal layer according to a video signal, wherein the display control section is configured to detect an application environment of the liquid crystal display panel and determine a minimum value of the liquid crystal drive voltage based on a phase-transition threshold voltage which causes energy of a splay alignment and energy of the bend alignment to be balanced with each other in the detected application environment.

According to a second aspect of this invention, there is provided a display control method for an OCB-mode liquid crystal display panel including a liquid crystal layer in which liquid crystal molecules are aligned in a bend alignment, comprising detecting an application environment of the liquid crystal display panel when a liquid crystal drive voltage is applied to the liquid crystal layer according to a video signal, and determining a minimum value of the liquid crystal drive voltage based on a phase-transition threshold voltage which causes energy of a splay alignment and energy of the bend alignment to be balanced with each other in the detected application environment.

According to a third aspect of this invention, there is provided a display control apparatus for an OCB-mode liquid crystal display panel including a liquid crystal layer in which liquid crystal molecules are aligned in a bend alignment, and a liquid crystal pixel in which a pair of electrodes are opposed via the liquid crystal layer interposed therebetween, the apparatus comprising a reference gradation voltage generating circuit which generates a preset number of reference gradation voltages, and a signal conversion circuit which converts pixel data to a pixel voltage to be applied to one of the pair of electrodes by selectively using the reference gradation voltages generated from the reference gradation voltage generating circuit, wherein the reference gradation voltage generating circuit is configured to determine a voltage range in which the reference gradation voltages are present, based on a phase-transition threshold voltage which causes energy of a splay alignment and energy of the bend alignment to be balanced with each other in an application environment of the liquid crystal display panel.

In the liquid crystal display panel, the display control method and the display control apparatus, the minimum value of the liquid crystal drive voltage or the pixel voltage is determined based on the phase-transition threshold voltage which causes energy of the splay alignment and energy of the bend alignment to be balanced with each other in an application environment (temperature, drive frequency, or the like) of the liquid crystal display panel. That is, even when the panel temperature, the drive frequency or the like varies, the liquid crystal drive voltage can be maintained in a range in which the alignment state of liquid crystal molecules is not reverse-transitioned from the bend alignment to the splay alignment. Thus, occurrence of reverse transition of the liquid crystal molecules caused by a variation in the application environment can be prevented.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing the circuit configuration of a liquid crystal display device according to a first embodiment of this invention;

FIG. 2 is a graph showing the relation between black-display and white-display voltages set in the conventional manner for an OCB-mode liquid crystal display panel shown in FIG. 1 and a phase-transition threshold voltage depending on panel temperature;

FIG. 3 is a graph showing the relation between black-display and white-display voltages set under the control of a minimum drive voltage determining section shown in FIG. 1 and the phase-transition threshold voltage depending on panel temperature;

FIG. 4 is a graph showing the relation between black-display and white-display voltages set under the control of a modification of the minimum drive voltage determining section shown in FIG. 1 and the phase-transition threshold voltage depending on panel temperature;

FIG. 5 shows a voltage-transmittance characteristic obtained in the liquid crystal display device shown in FIG. 1;

FIG. 6 shows a voltage dividing circuit which can be used to obtain the black-display and white-display voltages shown in FIG. 3;

FIG. 7 is a graph showing a variation in the black-display and white-display voltages caused when the voltage dividing circuit shown in FIG. 6 is used;

FIG. 8 is a graph showing a variation range of the transmittance corresponding to a variation in the white-display voltage shown in FIG. 7;

FIG. 9 is a diagram schematically showing the circuit configuration of a liquid crystal display device according to a second embodiment of this invention;

FIG. 10 is a diagram schematically showing the configuration of a source driver shown in FIG. 9;

FIG. 11 is a diagram showing the configuration of a reference gradation voltage generator circuit shown in FIGS. 9 and 10;

FIG. 12 is a graph showing a variation in the white-display voltage which is reduced in the liquid crystal display device shown in FIG. 9;

FIG. 13 is a graph showing a variation range of the transmittance corresponding to a variation in the white-display voltage shown in FIG. 12;

FIG. 14 is a diagram for illustrating that the phase-transition threshold voltage is changed depending on panel temperature in an OCB-mode liquid crystal display panel shown in FIG. 9;

FIG. 15 is a diagram showing the transmittance lowered when the white-display voltage is shifted based on the maximum value of the phase-transition threshold voltage shown in FIG. 14;

FIG. 16 is a diagram showing the relation between the phase-transition threshold voltage and the panel temperature which is measured in advance for the liquid crystal display panel shown in FIG. 9;

FIG. 17 is a diagram showing the range of the white-display voltage set with respect to the variation range of the phase-transition threshold voltage shown in FIG. 16; and

FIG. 18 is a diagram showing the splay alignment of liquid crystal molecules obtained before supply of power and the bend alignment of liquid crystal molecules transitioned from the splay alignment by phase transition driving after supply of power to perform white display and black display.

### DETAILED DESCRIPTION OF THE INVENTION

There will now be described a liquid crystal display device according to a first embodiment of this invention with reference to the accompanying drawings.

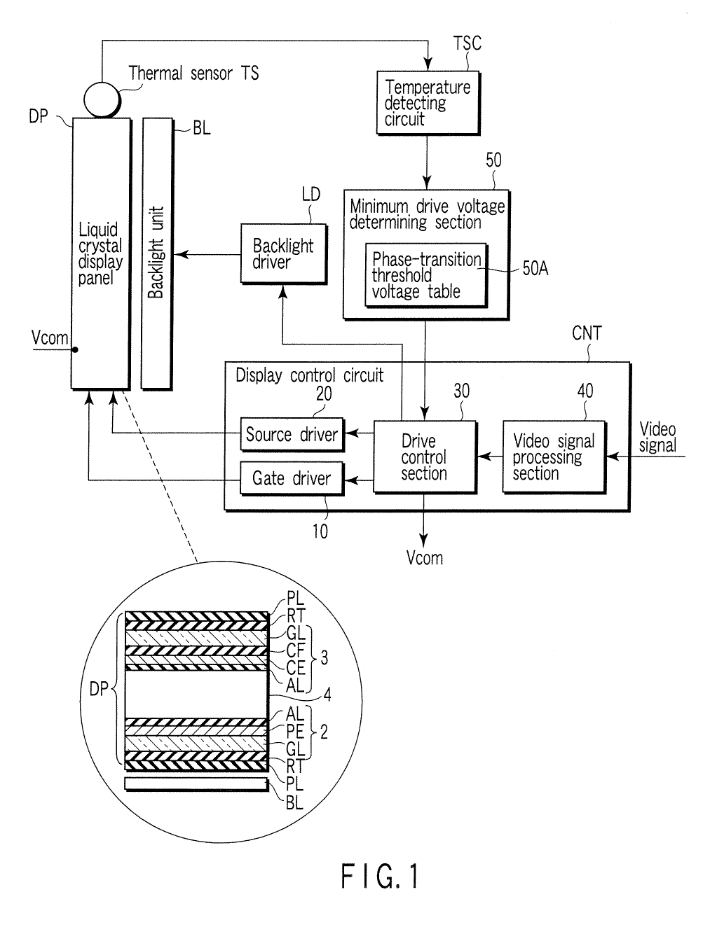

FIG. 1 schematically shows the circuit configuration of a liquid crystal display device. The liquid crystal display device includes an OCB-mode liquid crystal display panel DP of a transmissive type, backlight unit BL, thermal sensor TS, temperature detecting section TSC, minimum drive voltage determining section 50, display control circuit CNT and backlight driver LD.

The liquid crystal display panel DP includes an array substrate 2, a counter substrate 3, and a liquid crystal layer 4 held between the array substrate 2 and the counter substrate 4. The array substrate 1 includes a grass plate GL serving as a transparent insulating substrate, a plurality of pixel electrodes PE made of ITO and serving as transparent electrodes arranged on the glass plate GL, and an alignment film AL covering the pixel electrodes PE. The counter substrate 3 includes a glass plate GL serving as a transparent insulating substrate, a color filter CF arranged on the glass plate GL, and a common electrode CE made of ITO and serving as transparent electrodes arranged on the color filter CF in opposition to the pixel electrodes PE, and an alignment film AL covering the common electrode CE. The liquid crystal layer 4 which is provided in contact with the alignment films AL. Further, the liquid crystal display panel DP has a structure in which a pair of polarizers PL are respectively attached to the array substrate 2 and counter substrate 3 with optical retardation plates RT used as optical phase compensation films disposed therebetween. In a case where the liquid crystal display panel DP is of a reflective type or a transflective type, the entire or part of the pixel electrode PE will be provided as a reflective electrode made of a conductive metal material such as aluminum.

In the array substrate 2, the plurality of pixel electrodes PE are arrayed substantially in a matrix, a plurality of gate lines are arranged along the rows of pixel electrodes PE, a plurality of source lines are arranged along the columns of pixel electrodes PE, and a plurality of pixel switching elements are arranged near the intersections of the gate lines and the signal lines. Each of the pixel switching elements applies potential of the corresponding source line to the corresponding pixel electrode PE as a pixel voltage when it is driven via a corresponding gate line. The backlight unit BL is an illumination light source which illuminates the liquid crystal display panel DP and includes a cold-cathode fluorescent tube or light-emitting diode (LED), for example. The backlight driver LD is configured to periodically drive the backlight unit BL. The brightness of the liquid crystal display panel DP is controlled according to the ratio of the on-period and the off-period of the backlight unit BL. The thermal sensor TS is a module which converts temperature into an output signal such as a current signal. The temperature detecting section TSC is provided to detect an output signal of the thermal sensor TS as temperature and output temperature data indicating the detected temperature by use of numerical values. The minimum drive voltage determining section 50 derives a phase-transition threshold voltage corresponding to the temperature detected by the temperature detecting section TSC and determines the minimum value of the liquid crystal drive voltage based on the phase-transition threshold voltage. The phase-transition threshold voltage (or reverse-transition critical voltage) is an absolute value of the liquid crystal drive voltage applied for causing energy of the splay alignment and energy of the bend alignment to be balanced with each other, and depends on temperature which is one example of the application environment factors of the liquid crystal display panel DP. Therefore, the liquid crystal drive voltage is controlled to cope with a variation in the application environment. The minimum drive voltage determining section 50 includes a phase-transition threshold voltage table 50A holding phase-transition threshold voltages for various temperatures as data items expressing the phase-transition threshold voltages by use of numerical values. The minimum drive voltage determining section 50 searches the phase-transition threshold voltage table 50A for the phase-transition threshold voltage corresponding to temperature data from the temperature detecting section TSC and sets the obtained phase-transition threshold voltage as the minimum value of the liquid crystal drive voltage in the display control circuit CNT. For example, the liquid crystal display panel DP is operated in a normally white mode to perform white display when the liquid crystal drive voltage is set at the minimum value. If it is desired to operate the liquid crystal display panel DP in a normally black mode, black display is performed when the liquid crystal drive voltage is set at the minimum value.

The display control circuit CNT is provided to control the display operation of the liquid crystal display panel DP. With this control, the liquid crystal drive voltage is applied to the liquid crystal layer according to a video signal input from the external signal source. The display control circuit CNT includes a gate driver 10 which sequentially drives the gate lines, a source driver 20 which outputs pixel voltages for the pixel electrodes PE of each row to drive the source lines in parallel while a corresponding gate line is being driven, a drive control section 30 which controls the operations of the gate driver 10, source driver 20 and backlight driver LD, and a video signal processing section 40 which processes a video signal input from the external signal source. A common voltage Vcom is supplied from the drive control section 30 to the common electrode CE of the liquid crystal display panel DP. Further, the backlight driver LD determines the ratio of the on-period and the off-period of the backlight unit BL under the control of the drive control section 30. The pixel voltage is a voltage applied to the pixel electrode PE with the potential of the common electrode CE used as a reference, and the liquid crystal drive voltage is a potential difference between the pixel electrode PE and the common electrode CE. In this embodiment, the common voltage is fixed at zero, for example. Thus, the liquid crystal drive voltage has a value equal to that of the pixel voltage.

Next, the operation of the liquid crystal display device is explained. If a variation in the temperature of the liquid crystal display panel DP occurs due to the ambient temperature at a place where the liquid crystal display device is located or thermal irradiation from the backlight unit BL, the variation in the temperature is reflected in an output signal of the thermal sensor TS. When the temperature detecting section TSC detects the temperature of the liquid crystal display panel DP based on an output signal of the thermal sensor TS, it derives a phase-transition threshold voltage corresponding to the detected temperature by use of the phase-transition threshold voltage table 50A and determines the minimum value of the liquid crystal drive voltage substantially equal to the phase-transition threshold voltage Vc or a voltage which is slightly greater than the phase-transition threshold voltage Vc and which may be obtained by adding a voltage, for example, of at least 0.3 V to the phase transition threshold voltage Vc as a predetermined margin.

In the display control circuit CNT, the drive control section 30 determines the range of the pixel voltage for a video signal, such that the minimum value of the liquid crystal application voltage determined by the minimum drive voltage determining section 50 serves as a white-display voltage which is the pixel voltage for white display. Further, the drive control section 30 controls the gate driver 10 such that one gate line is driven each time pixel data items for the pixel electrodes of one row are obtained from the video signal processing section 40, and controls the source driver 20 to convert the pixel data items to pixel voltages of the determined range and output these pixel voltages to the source lines.

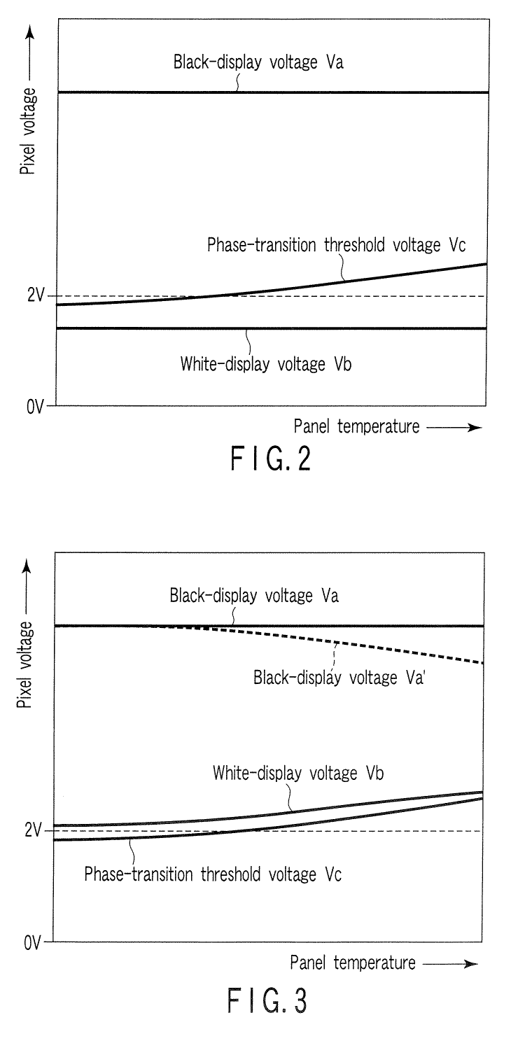

FIG. 2 shows the relation between black-display and white-display voltages Va, Vb set in the conventional manner for the liquid crystal display panel DP shown in FIG. 1 and a phase-transition threshold voltage Vc depending on panel temperature as a comparison example. For example, when the black insertion drive operation is performed, the black-display voltage Va and white-display voltage Vb may be set in the relation with respect to the phase-transition threshold voltage Vc as shown in FIG. 2. In this example, the black-display voltage Va and white-display voltage Vb are respectively set as the maximum value and minimum value of the pixel voltage. That is, the pixel voltage is set to a value corresponding to a video signal in a range between the black-display voltage Va and the white-display voltage Vb. Specifically, the source driver 10 outputs the black-display voltage Va as the pixel voltage for black display, outputs the white-display voltage Vb as the pixel voltage for white display and outputs a voltage between the black-display voltage Va and white-display voltage Vb as the pixel voltage for intermediate gradation display.

If a voltage smaller than the phase-transition threshold voltage Vc (e.g., a voltage close to 0 V) is continuously applied to the liquid crystal layer 4, the alignment state of liquid crystal molecules is gradually transitioned from the bend alignment to the splay alignment and reverse transition finally occurs. Therefore, the phase-transition threshold voltage Vc can be regarded as the maximum value of a voltage which causes occurrence of reverse transition by continuous application of the above voltage to the liquid crystal layer 4. Since the white-display voltage Vb is always smaller than the phase-transition threshold voltage Vc in the panel temperature range shown in FIG. 2, reverse transition occurs when the white display is continued without black insertion driving. Further, liquid crystal molecules tend to easily move with a temperature rise, thereby to cause reverse transition from the bend alignment to the splay alignment to easily occur. The phase-transition threshold voltage Vc is approximately 2 V at normal temperatures, but it increases with temperature of the liquid crystal display panel DP as shown in FIG. 2.

Therefore, the black-display voltage Va and white-display voltage Vb are set as shown in FIG. 3 with respect to the phase-transition threshold voltage Vc depending on the panel temperature under the control of the minimum drive voltage determining section 50 shown in FIG. 1. As described above, the source driver 10 outputs the black-display voltage Va as the pixel voltage for black display, outputs the white-display voltage Vb as the pixel voltage for white display and outputs a voltage between the black-display voltage Va and white-display voltage Vb as the pixel voltage for a intermediate gradation display. However, the white-display voltage Vb is set so that it will vary together with the phase-transition threshold voltage Vc upon a rise in the temperature of the liquid crystal display panel DP and will be maintained to exceed the phase-transition threshold voltage Vc.

In the first embodiment, reverse transition of liquid crystal molecules is prevented. Further, the liquid crystal drive voltage is maintained over the phase-transition threshold voltage Vc even if the panel temperature is changed. Thus, reverse transition of liquid crystal molecules can be prevented irrespective of the panel temperature. Although the backlight unit BL is blinked for dimming control, the black insertion driving is not required. Thus, a black belt-like image which moves from the upper end side to the lower end side will not appear on the liquid crystal display panel due to a difference between the black insertion period and the off-period of the backlight unit BL.

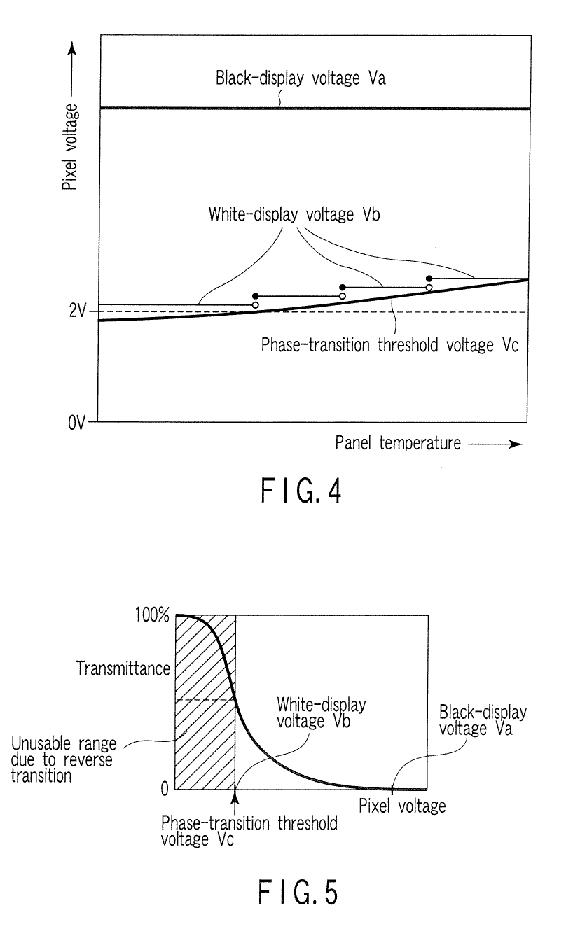

Next, a modification of the minimum drive voltage determining section 50 shown in FIG. 1 is explained. In this modification, if a table in which phase-transition threshold voltages Vc (or voltages slightly exceeding the phase-transition threshold voltages Vc) are held as the minimum values of the liquid crystal drive voltage for various temperatures of the liquid crystal display panel DP is provided instead of the phase-transition threshold voltage table 50A, the minimum value of the liquid crystal drive voltage suited to the detected temperature can be directly acquired. FIG. 4 shows the relation between the black-display and white-display voltages Va, Vb set in this modification and the phase-transition threshold voltage Vc depending on the panel temperature. In this example, the white-display voltage Vb corresponds to the minimum value of the liquid crystal drive voltage and is applied as a constant voltage in a preset temperature range of the liquid crystal display panel DP. In the table of the modification, a voltage exceeding the phase-transition threshold voltage Vc is held for each preset temperature range as the minimum value of the liquid crystal drive voltage. The minimum drive voltage determining section 50 searches the table for the minimum value of the liquid crystal drive voltage of a preset temperature range including the temperature detected by the temperature detecting section TSC and sets the obtained minimum value of the liquid crystal drive voltage (that is, white-display voltage Vb) in the display control circuit CNT. If the minimum drive voltage determining section 50 is thus configured, the white-display voltage Vb is changed in a step-by-step manner with a rise or a fall in the temperature of the liquid crystal display panel DP.

In this modification, the white-display voltage Vb shown in FIG. 4 is not changed as far as the temperature of the liquid crystal display panel DP lies in the preset temperature range. Therefore, the conversion result of digital-to-analog conversion from pixel data to a pixel voltage can be prevented from unnecessarily fluctuating due to a slight temperature variation and a stable display image which looks natural can be obtained. Further, in FIG. 3, the white-display voltage Vb continuously varies with a change of the panel temperature, but it becomes easy to control the digital-to-analog conversion when it varies in a step-by-step manner as shown in FIG. 4.

In FIGS. 3 and 4, the white-display voltage Vb is set to the phase-transition threshold voltage Vc or a voltage which slightly exceeds the phase-transition threshold voltage Vc. However, when a difference between the white-display voltage Vb and the phase-transition threshold voltage Vc is increased, it becomes necessary to pay much attention to the fact that the contrast and luminance will be lowered. Thus, it is preferable that the white-display voltage (minimum drive voltage) exceeds the phase-transition threshold voltage Vc by 0 to 0.5 V, more preferably 0.1 to 0.5 V. Further, when a sufficiently large voltage obtained according to a video signal is frequently applied to the liquid crystal layer 4 as the liquid crystal drive voltage, occurrence of reverse transition can be prevented without causing any problem even if the white-display voltage Vb is set slightly smaller than the phase-transition threshold voltage Vc. In this case, it is preferable that the white-display voltage (minimum drive voltage) is not less than the phase-transition threshold voltage Vc by 0.05 V or more.

For example, when a still image is displayed on the liquid crystal display panel DP, the drive frequency of the liquid crystal display panel DP can be lowered. If the still image is an image of almost white displayed on the entire screen, reverse transition is likely to occur due to a lowering in the drive frequency. Therefore, it is preferable to detect not only the panel temperature but also the drive frequency as the application environment factors of the liquid crystal display panel DP and reflect the detected factors in the minimum value of the liquid crystal drive voltage.

Illumination light sources other than the cold-cathode fluorescent tube can be used as the backlight unit BL. For example, LEDs or electroluminescent (EL) elements can be used as the backlight unit BL.

In the first embodiment, as shown in FIG. 5, pixel data is converted to a pixel voltage in a range between the white-display voltage Vb and the black-display voltage Va. The white-display voltage Vb is maintained over the phase-transition threshold voltage Vc which causes energy of the splay alignment and energy of the bend alignment to be balanced with each other.

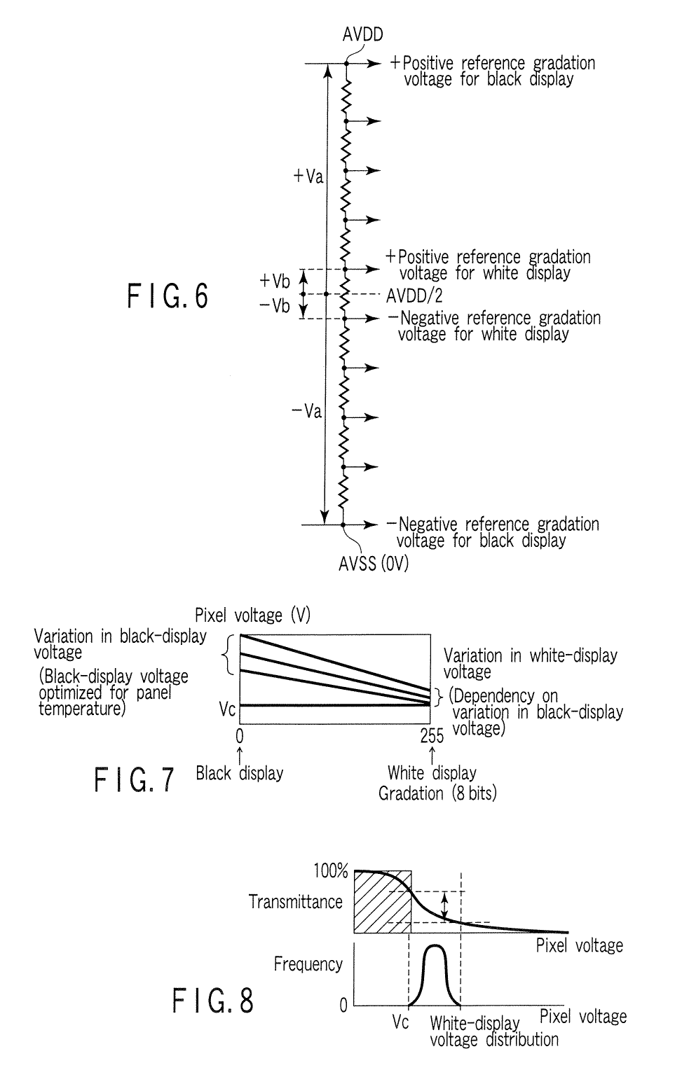

Also, for the black-display voltage Va shown in FIG. 5, it is preferable that the voltage Va is optimized as a black-display voltage Va′ shown in FIG. 3 for the temperature of the liquid crystal display panel in order to prevent black display from becoming whitish. For example, if the power supply voltage is divided by use of a ladder resistor section shown in FIG. 6, white-display voltages +Vb, −Vb of positive and negative polarities and black-display voltages +Va, −Va of positive and negative polarities necessary for polarity inversion of the liquid crystal drive voltage can be obtained. The black-display voltages +Va, −Va can be changed by adjusting the power supply voltage across the ladder resistor section.

However, when the black-display voltages +Va, −Va are optimized in the manner described above, the white-display voltages +Vb, −Vb obtained by dividing the power supply voltage will vary. FIG. 7 shows the result of optimization of the black-display voltage for three different temperatures of the liquid crystal display panel. That is, when the black-display voltage varies with respect to pixel data of gradation “0” which specifies black display by optimization, the white-display voltage will also vary with respect to pixel data of gradation “255” which specifies white display. Since the transmittance is set to be almost 100% for the white-display voltage when the dynamic bend system is used, variation in the transmittance with respect to variation in the white-display voltage in the voltage-transmittance characteristic curve is relatively small. However, when the static bend system is used, a variation in the transmittance with respect to a variation in the white-display voltage in the voltage-transmittance characteristic curve increases as shown in FIG. 8. Particularly, in a case where the dynamic bend system and the static bend system are selectable for use in the liquid crystal display device, the transmittance abruptly varies due to a variation in the white-display voltage when the static bend system is used. As a result, the variation in the white-display voltage is observed as a significant luminance difference.

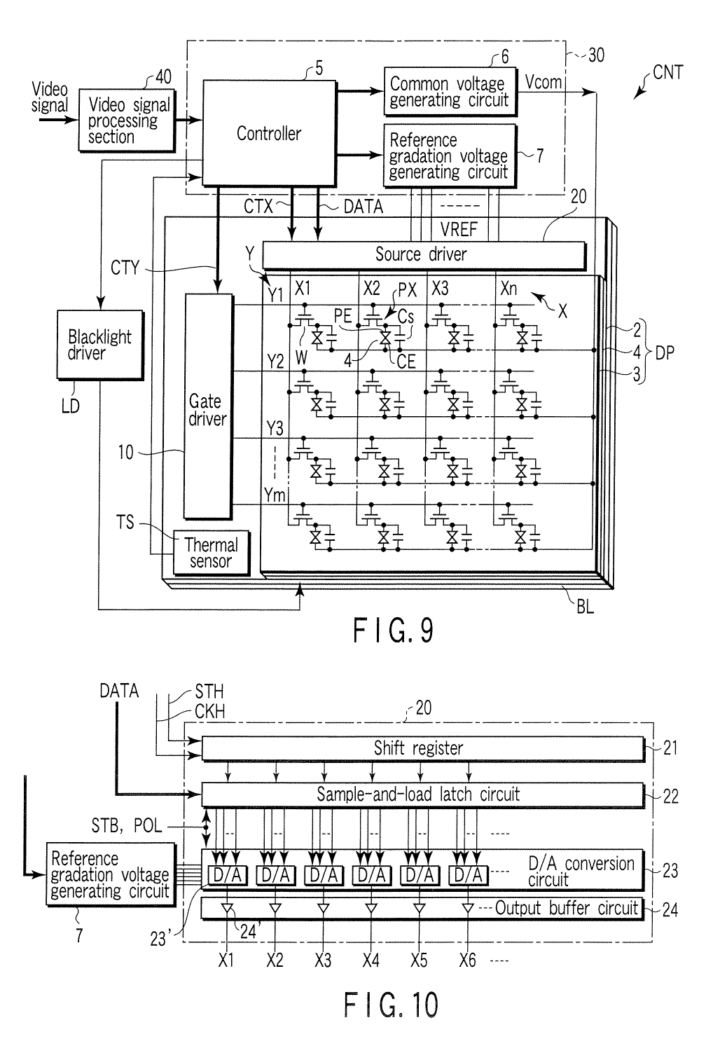

Next, a liquid crystal display device according to a second embodiment of this invention is explained with reference to the accompanying drawings. In the first embodiment, the detailed explanation of the circuit configuration and the like for generating the white- and black-display voltages is omitted in order to emphasize the main concept of this invention. Therefore, in the second embodiment, the circuit configuration is explained in more detail. FIG. 9 schematically shows the circuit configuration of the liquid crystal display device according to the second embodiment of this invention. In FIG. 9, functioned portions similar to those of the first embodiment are denoted by the same reference symbols.

Like the first embodiment, the liquid crystal display device includes an OCB-mode liquid crystal display panel DP, backlight unit BL, thermal sensor TS, display control circuit CNT and backlight driver LD. The display control circuit CNT has a gate driver 10, source driver 20, drive control section 30 and video signal processing section 40.

The liquid crystal display panel DP has a structure in which a liquid crystal layer 4 is held between an array substrate 2 and a counter substrate 3. The array substrate 2 includes a plurality of pixel electrodes PE arrayed in a matrix on a transparent insulating substrate such as a glass plate, a plurality of gate lines Y (Y1 to Ym) arranged along the rows of pixel electrodes PE, a plurality of source lines X (X1 to Xn) arranged along the columns of pixel electrodes PE, and a plurality of pixel switching elements W arranged near the intersections of the gate lines Y and the source lines X. The gate driver 10 and source driver 20 are provided on the array substrate 2. The gate driver 10 sequentially drives the gate lines Y and the source driver 20 drives the source lines X while each gate line is being driven. Each pixel switching element W is formed of a polysilicon thin film transistor, for example. In this case, the gate of each thin film transistor is connected to a corresponding one of the gate lines Y and the source-drain path thereof is connected between a corresponding one of the source lines X and a corresponding one of the pixel electrodes PE. The gate driver 10 is configured by use of polysilicon thin film transistors which are simultaneously formed in the same step as the pixel switching element W. Further, the source driver 20 is an integrated circuit (IC) chip mounted on the array substrate 2 by use of the chip-on-glass (COG) technique.

The counter substrate 3 includes a color filter (not shown) arranged on a transparent insulating substrate such as a glass plate, a common electrode CE arranged on the color filter to face the pixel electrodes PE, and the like. For example, each of the pixel electrodes PE and the common electrode CE are formed of a transparent electrode material such as ITO and configure a liquid crystal pixel PX in cooperation with a pixel region of the liquid crystal layer 4 which is held between the pixel electrode PE and the common electrode CE. The alignment of liquid crystal molecules in the pixel region is controlled according to an electric field from the electrodes PE, CE. Further, all the pixels PX have storage capacitances Cs. The storage capacitances Cs can be obtained by electrically connecting the common electrode CE to a plurality of storage capacitance lines capacitively coupled with the rows of pixel electrodes PE on the array substrate 2 side.

The drive control section 30 includes a controller 5, common voltage generating circuit 6 and reference gradation voltage generating circuit 7. The controller 5 is configured to include the temperature detecting circuit TSC and minimum drive voltage determining section 50 provided in the first embodiment and controls the common voltage generating circuit 6, reference gradation voltage generating circuit 7, gate driver 10, source driver 20, and backlight driver LD. The common voltage generating circuit 6 supplies common voltage Vcom to the common electrode CE on the counter substrate 3. The reference gradation voltage generating circuit 7 generates a plurality of reference gradation voltages VREF used to convert, for example, 8-bit pixel data DATA for each pixel PX derived from a digital video signal to a pixel voltage. The pixel voltage is applied to the pixel electrode PE with the potential of the common electrode CE used as a reference.

The controller 5 generates a control signal CTY used to sequentially select the gate lines Y for each vertical scanning period, a control signal CTX used to respectively assign pixel data items DATA for pixels PX of one row (line) contained in the video signal to the source lines X for each horizontal scanning period (1H), for example. The control signal CTY contains a vertical start signal STV which is a pulse generated in the vertical scanning period (1V) and a vertical clock signal CKV which contains pulses generated for the number of gate lines Y in the vertical scanning period. Further, the control signal CTX contains a horizontal start signal STH which is a pulse generated in the horizontal scanning period (1H), a horizontal clock signal CKH which contains pulses generated for the number of source lines X in the horizontal scanning period, a strobe signal STB which is a pulse generated with a preset time delay with respect to the start signal STH in the horizontal scanning period (1H) to convert pixel data items DATA for pixels of one line to pixel voltages in parallel and output the thus converted voltages to the respective source line X1 to Xn, and a polarity signal POL used to invert the polarity of the pixel voltage for each horizontal scanning period and for each vertical scanning period. The control signal CTY is supplied from the controller 5 to the gate driver 10 and the control signal CTX is supplied from the controller 5 to the source driver 20 together with the pixel data items DATA.

Under the control of control signal CTY, the gate driver 10 sequentially selects the gate lines Y and supplies a scanning signal, which turns on the pixel switching element W, to the selected gate line Y.

FIG. 10 schematically shows the configuration of the source driver 20 shown in FIG. 9. The source driver 20 includes a shift register 21 which shifts the horizontal start signal STH in synchronism with the horizontal clock signal CKH to control timings of serial-to-parallel conversion for the digital video signal, a sample-and-load latch 22 which sequentially latches pixel data items DATA for the pixels PX of one line under the control of the shift register 21 and outputs the latched pixel data items DATA in parallel, a digital-to-analog (D/A) converter circuit 23 which converts the pixel data items DATA to analog pixel voltages, and an output buffer circuit 24 which outputs the pixel voltages obtained from the digital-to-analog converter circuit 23 to the source lines X1 to Xn. The digital-to-analog converter circuit 23 is configured to refer to the reference gradation voltages VREF generated from the reference gradation voltage generating circuit 7.

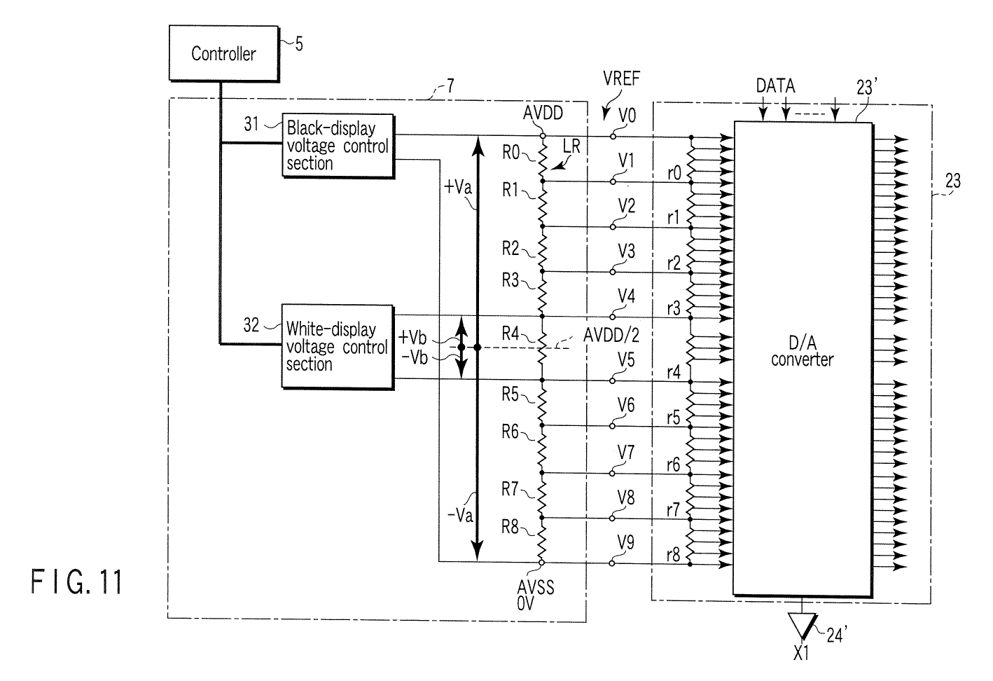

As shown in FIG. 11, the reference gradation voltage generating circuit 7 includes a black-display voltage control section 31 which outputs a first power supply voltage variably changed as black-display voltages +Va, −Va, a white-display voltage control section 32 which outputs a second power supply voltage variably changed as white-display voltages +Vb, −Vb, and a ladder resistor section LR connected to the black-display voltage control section 31 and the white-display voltage control section 32 to divide the difference voltage between the first and second power supply voltages into a preset number of reference gradation voltages V0 to V9. The ladder resistor section LR includes resistors R0 to R8 connected in series between power supply terminals AVDD and AVSS. The first power supply voltage is supplied across the ladder resistor section LR via the power supply terminals AVDD and AVSS to obtain the positive polarity black-display voltage +Va and negative polarity black-display voltage −Va with respect to the center point of voltage division. Further, the second power supply voltage is supplied across the resistor R4 containing the center point of voltage division in the ladder resistor section LR to obtain the positive polarity white-display voltage +Vb and negative polarity white-display voltage −Vb with respect to the center point of voltage division.

The black-display voltage control section 31 is associated with the controller 5 to optimize the black-display voltages +Va, −Va with respect to the temperature of the liquid crystal display panel DP. In the liquid crystal display panel DP, each OCB liquid crystal pixel PX is driven by the pixel voltage applied in a state in which the alignment state of liquid crystal molecules is transitioned in advance from the splay alignment to the bend alignment. In order to prevent occurrence of reverse transition from the bend alignment to the splay alignment in the static bend system, the white-display voltage control section 32 is associated with the controller 5 to set the white-display voltages +Vb, −Vb to values slightly greater than the phase-transition threshold voltage Vc which causes energy of the splay alignment and energy of the bend alignment to be balanced with each other. In order to make the first and second power supply voltages variable as the black-display voltages +Va, −Va and white-display voltages +Vb, −Vb, each of the black-display voltage control section 31 and white-display voltage control section 32 is configured by using a digital-to-analog converter which converts numerical control data for the black-display or white-display voltage, for example, from the controller 5 to a voltage and an output buffer which stably outputs the thus converted voltage. The thermal sensor TS is disposed in a place where the temperature of the liquid crystal display panel DP can be adequately sensed and the temperature sensed by the thermal sensor TS is processed in the controller 5 to determine the optimum values of the black-display voltages +Va, −Va and white-display voltages +Vb, −Vb.

For example, as shown in FIGS. 10 and 11, the digital-to-analog converter circuit 23 of the source driver 20 includes a plurality of digital-to-analog converters 23′ and input resistor groups r0 to r8 connected between the voltage output terminals of the reference gradation voltage generating circuit 7. The input resistor groups r0 to r8 are commonly provided for the digital-to-analog converters 23′ and output a preset number of gradation voltages obtained by dividing voltages between the voltage output terminals to the digital-to-analog converters 23′. Each of the digital-to-analog converters 23′ selects one of the preset number of gradation voltages according to the pixel data item DATA output from the sample-and-load latch 22 and outputs the selected gradation voltage to the output buffer circuit 24 as an analog pixel voltage. The output buffer circuit 24 includes a plurality of buffer amplifiers 24′ which output analog pixel voltages from the digital-to-analog converters 23′ to respective source lines X1, X2, X3, . . . .

The digital-to-analog converter circuit 23 and output buffer circuit 24 serve as a signal conversion circuit which converts pixel data items DATA of one line to respective pixel voltages by selectively using the preset number of gradation voltages obtained from the input resistor groups r0 to r8 connected in series to divide the voltages between the voltage output terminals of the reference gradation voltage generating circuit 7, and outputs the thus converted pixel voltages to the respective source lines X1 to Xn.

The pixel voltages on the source lines X1 to Xn are respectively supplied to the corresponding pixel electrodes PE via the pixel switching elements W of one line driven by the scanning signal. The common voltage Vcom is output from the common voltage generating circuit 6 to the common electrode CE. On the source driver 20 side, each digital-to-analog converter 23′ inverts the polarity of the pixel voltage with respect to AVDD/2 which is equal to the common voltage Vcom.

In the second embodiment, the black-display voltage control section 31 variably changes the first power supply voltage to optimize the black-display voltages +Va, −Va with respect to the temperature of the liquid crystal display panel DP. Further, the white-display voltage control section 32 sets the white-display voltages +Vb, −Vb to values slightly greater than the phase-transition threshold voltage Vc which causes energy of the splay alignment and energy of the bend alignment to be balanced with each other.

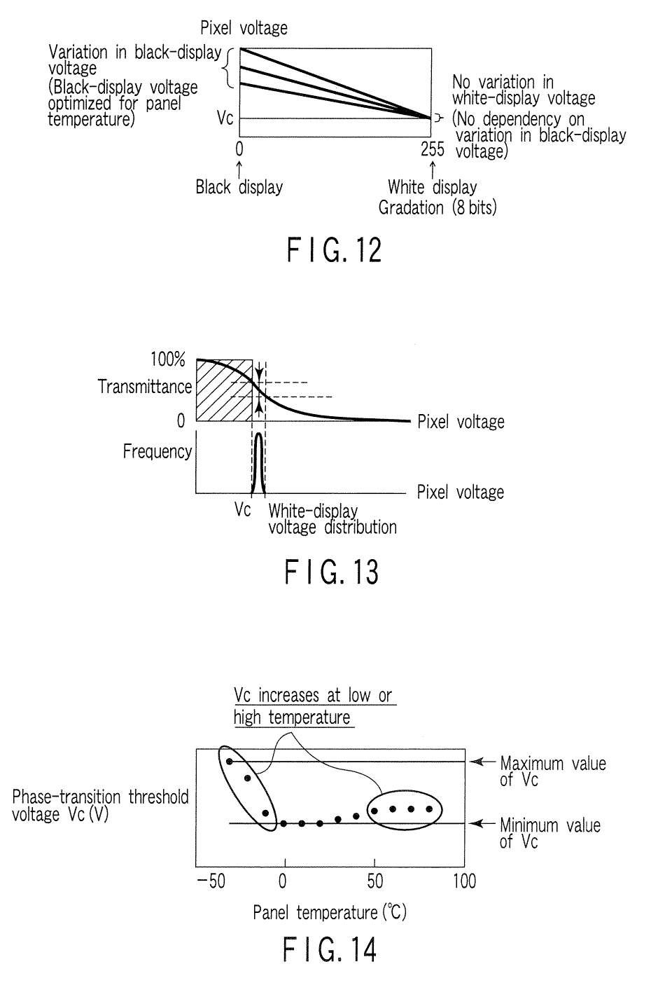

FIG. 12 shows the result of optimization of the black-display voltages +Va, −Va with respect to three different temperatures of the liquid crystal display panel. The black-display voltages +Va, −Va vary with respect to pixel data of gradation “0” which specifies black display by optimization, but the white-display voltage does not substantially vary with respect to pixel data of gradation “255” which specifies white display. Thus, if a variation in the white-display voltages +Vb, −Vb is limited in the static bend system, variation in the transmittance with respect to variation in the white-display voltages +Vb, −Vb is reduced in the voltage-transmittance characteristic curve as shown in FIG. 13. Therefore, a significant luminance difference due to variation in the white-display voltages +Vb, −Vb will be not observed.

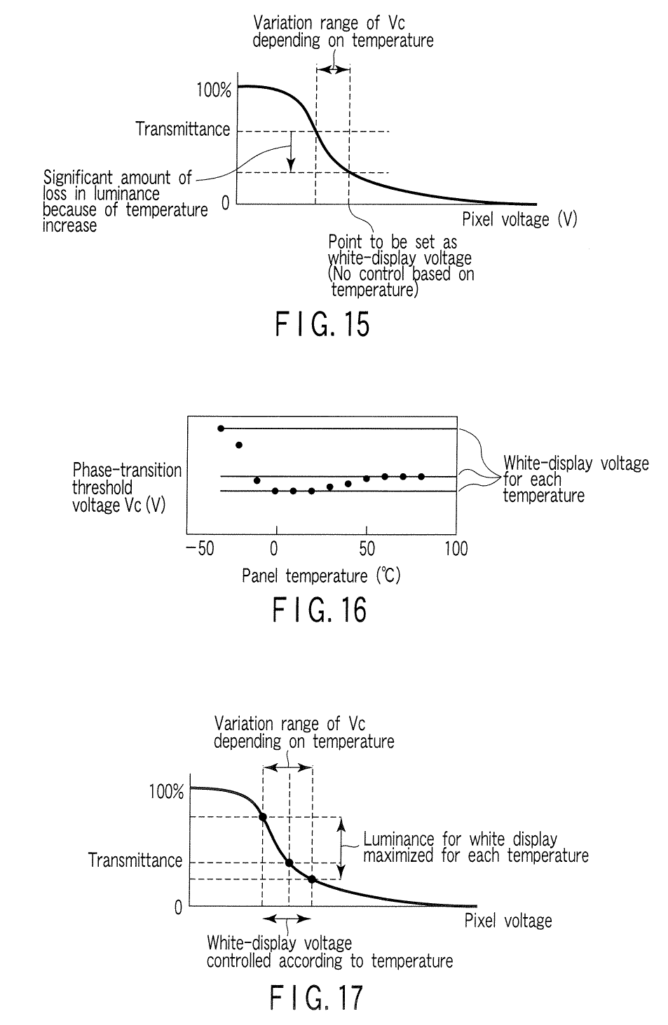

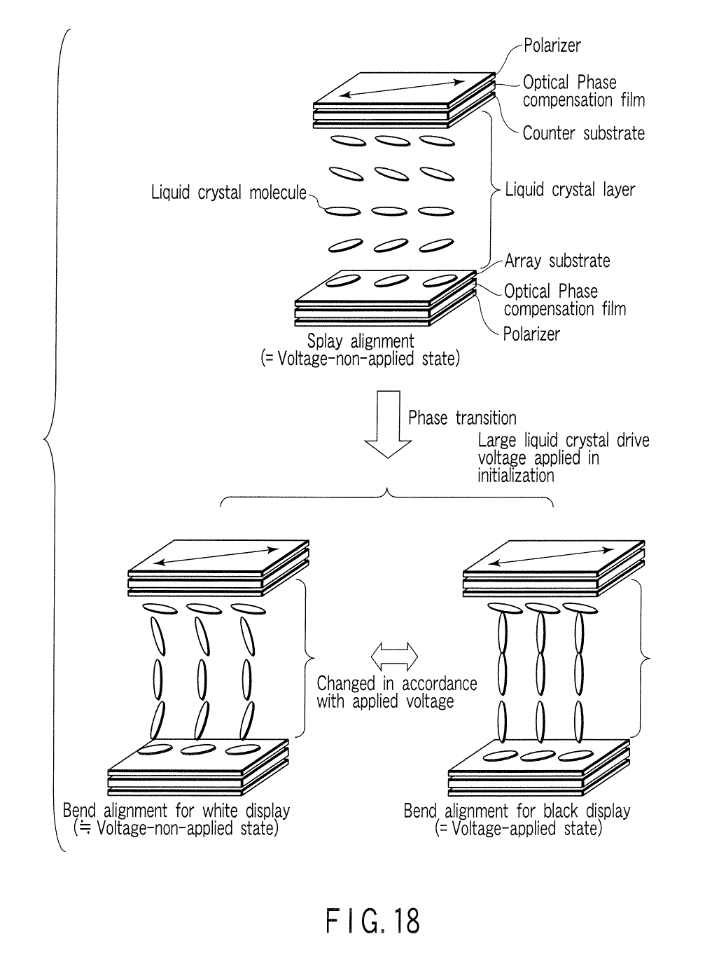

As is explained in the first embodiment, the phase-transition threshold voltage Vc depends on the temperature of the liquid crystal display panel DP. As shown in FIG. 14, when the liquid crystal display panel DP is used in a wide temperature range, it is necessary for the white-display voltage to be shifted to the maximum value of the phase-transition threshold voltage Vc which varies in the above temperature range. In the first embodiment, much attention is paid to the fact that reverse transition of liquid crystal molecules is prevented, but since the white-display voltage in the static bend system is greater than that in the dynamic bend system, the transmittance of the liquid crystal display panel is lowered with respect to the maximum transmittance of 100% at the time of white display. In this situation, if the white-display voltage is set to cope with a variation in the phase-transition threshold voltage Vc as shown in FIG. 15, it becomes difficult to attain luminance for white display which sufficiently satisfies the specification required for the product.

Therefore, when the static bend system is used to prevent reverse transition from the bend alignment to the splay alignment, it is necessary to suppress the luminance for white display from lowering in a range of room temperatures.

In the above embodiment, the black-display voltage control section 31 variably changes the first power supply voltage to optimize the black-display voltages +Va, −Va with respect to the temperature of the liquid crystal display panel DP. Further, the white-display voltage control section 32 sets the white-display voltages +Vb, −Vb to values slightly greater than the phase-transition threshold voltage Vc which causes energy of the splay alignment and energy of the bend alignment to be balanced with each other.

FIG. 16 shows the relation between the phase-transition threshold voltage Vc and the panel temperature previously measured for the liquid crystal display panel DP. That is, the controller 5 derives the phase-transition threshold voltage Vc corresponding to a temperature detected by the thermal sensor TS from the characteristic of panel temperature to phase-transition threshold voltage Vc shown in FIG. 14, and determines the phase-transition threshold voltage Vc or a voltage slightly greater than the phase-transition threshold voltage Vc as the white-display voltages +Vb, −Vb.

In a case where the liquid crystal display panel DP is used in a range of room temperatures, the phase-transition threshold voltage Vc has a value around the minimum value as shown in FIG. 16. Therefore, the white-display voltages +Vb, −Vb are controlled to increase when the detected temperature is higher or lower than a predetermined room temperature range from 10 to 40° C., for example. As a result, as can be understood from FIG. 17, the white-display voltages +Vb, −Vb are kept small in the predetermined room temperature range to enhance the transmittance for white display.

The reference gradation voltage generating circuit 7 is provided for the liquid crystal display panel DP having the OCB liquid crystal pixels PX driven by the pixel voltages applied in a state in which the alignment state of liquid crystal molecules is transitioned in advance from the splay alignment to the bend alignment, and determines a voltage range in which the preset number of reference gradation voltages VREF are present, based on the phase-transition threshold voltage Vc which varies depending on the temperature of the liquid crystal display panel DP and causes energy of the splay alignment and energy of the bend alignment to be balanced with each other in the liquid crystal display panel DP. Specifically, the voltage range in which the preset number of reference gradation voltages VREF are present is set between the black-display voltage +Va and white-display voltage +Vb or between the black-display voltage −Va and white-display voltage −Vb. Luminance for white display can be prevented from being lowered in a range of room temperatures, by optimizing the voltage range for each temperature of the liquid crystal display panel DP as described above when the static bend system is used to prevent reverse transition from the bend alignment to the splay alignment.

Moreover, in the second embodiment, the black-display voltage control section 31 and the white-display voltage control section 32 are configured to variably change the first power supply voltage and the second power supply voltage to adjust the black-display voltages +Va, −Va and the white-display voltages +Vb, −Vb, respectively. However, if attention is paid only to prevention of reverse transition of liquid crystal molecules, as in the first embodiment, it is necessary that the minimum value of the liquid crystal drive voltage (i.e., the white-display voltage) be determined. In this case, a ladder resistor section and a selector may be provided in the reference gradation voltage generating circuit 7, for example. The ladder resistor section includes resistors the number of which exceeds that of the resistors R1 to R8 and which are connected in series to divide a power supply voltage greater than the second power source voltage. In this ladder resistor section, a first group of four resistors serves as the resistors R0 to R3, and a second group of four resistors serves as the resistors R5 to R8. The selector selects the first and second groups of resistors in the ladder resistor section such that the selection is shifted in accordance with the application environment such as the temperature and driving frequency of the liquid crystal display panel DP. Thus, the voltages V0 to V4 are obtained from the first group of resistors, and the voltages V5 to V9 are obtained from the second group of resistors.

The reference gradation voltage generating circuit 7 is configured to limit the pixel voltage to a range suited to the static bend system, but it is applicable to a case wherein the dynamic bend system and static bend system are switched in the liquid crystal display device. In this case, the white-display voltages +Vb, −Vb are set to be less than the phase-transition threshold voltage Vc by the white-display voltage control section 32 in the dynamic bend system.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising:
an OCB-mode liquid crystal display panel including a liquid crystal layer in which liquid crystal molecules are aligned in a bend alignment; and
a display control section which applies a liquid crystal drive voltage to said liquid crystal layer according to a video signal;
wherein said display control section is configured to detect an application environment of said liquid crystal display panel and determine a minimum value of the liquid crystal drive voltage based on a phase-transition threshold voltage which causes energy of a splay alignment and energy of the bend alignment to be balanced with each other in the detected application environment.

2. The liquid crystal display device according to claim 1, wherein said display control section includes a table which holds data of voltages exceeding the phase-transition threshold voltage and provided as minimum values of the liquid crystal drive voltage for predetermined panel temperature ranges different from each other, and is configured to derive a voltage held in said table for a panel temperature range including the temperature of said liquid crystal display panel detected as the application environment and determine the derived voltage as the minimum value of the liquid crystal drive voltage.

3. The liquid crystal display device according to claim 1, wherein the minimum value of the liquid crystal drive voltage is a white-display voltage to be used for white display.

4. The liquid crystal display device according to claim 1, wherein said liquid crystal display panel includes a liquid crystal pixel in which a pair of electrodes are opposed to each other with said liquid crystal layer interposed therebetween,
said display control section includes a reference gradation voltage generating circuit which generates a preset number of reference gradation voltages, a signal conversion circuit which converts pixel data contained in the video signal to a pixel voltage to be applied to one of the pair of electrodes, by selectively using the reference gradation voltages from said reference gradation voltage generating circuit, and
said reference gradation voltage generating circuit includes a black-display voltage control section which outputs a first power supply voltage variably changed as a black-display voltage, a white-display voltage control section which outputs a second power supply voltage variably changed as a white-display voltage, and a ladder resistor section connected to said black-display voltage control section and said white-display voltage control section to divide difference voltage between the first and second power supply voltages into the reference gradation voltages.

5. The liquid crystal display device according to claim 4, wherein said black-display voltage control section is configured to optimize the black-display voltage with respect to the temperature of said liquid crystal display panel.

6. The liquid crystal display device according to claim 5, wherein said white-display voltage control section is configured to set the white-display voltage to a value slightly greater than the phase-transition threshold voltage which causes energy of the splay alignment and energy of the bend alignment to be balanced with each other.

7. The liquid crystal display device according to claim 4, wherein the first power supply voltage is supplied across the ladder resistor section to obtain a positive polarity black-display voltage and a negative polarity black-display voltage with respect to the center point of voltage division, and the second power supply voltage is supplied across a portion containing the center point of voltage division in the ladder resistor section to obtain a positive polarity white-display voltage and a negative polarity white-display voltage with respect to the center point of voltage division.

8. A display control method for an OCB-mode liquid crystal display panel including a liquid crystal layer in which liquid crystal molecules are aligned in a bend alignment, said method comprising:
detecting an application environment of said liquid crystal display panel when a liquid crystal drive voltage is applied to said liquid crystal layer according to a video signal; and
determining a minimum value of the liquid crystal drive voltage based on a phase-transition threshold voltage which causes energy of a splay alignment and energy of the bend alignment to be balanced with each other in the detected application environment.

9. The display control method according to claim 8, further comprising:
providing a table which holds data of voltages exceeding the phase-transition threshold voltage and provided as minimum values of the liquid crystal drive voltage for predetermined panel temperature ranges different from each other,
deriving a voltage held in said table for a panel temperature range including the temperature of said liquid crystal display panel detected as the application environment to determine the derived voltage as the minimum value of the liquid crystal drive voltage.

10. The display control method according to claim 8, wherein the minimum value of the liquid crystal drive voltage is a white-display voltage to be used for white display.

11. A display control apparatus for an OCB-mode liquid crystal display panel including a liquid crystal layer in which liquid crystal molecules are aligned in a bend alignment, and a liquid crystal pixel in which a pair of electrodes are opposed such that said liquid crystal layer is interposed therebetween, the apparatus comprising:
a reference gradation voltage generating circuit which generates a preset number of reference gradation voltages; and
a signal conversion circuit which converts pixel data to a pixel voltage to be applied to one of the pair of electrodes by selectively using the reference gradation voltages generated from said reference gradation voltage generating circuit;
wherein said reference gradation voltage generating circuit is configured to determine a voltage range in which the reference gradation voltages are present, based on a phase-transition threshold voltage which causes energy of a splay alignment and energy of the bend alignment to be balanced with each other in an application environment of said liquid crystal display panel.

12. The display control apparatus according to claim 11, wherein said reference gradation voltage generating circuit includes a black-display voltage control section which outputs a first power supply voltage variably changed as a black-display voltage for black display, a white-display voltage control section which outputs a second power supply voltage variably changed as a white-display voltage for white display, and a ladder resistor section connected to said black-display voltage control section and said white-display voltage control section to divide difference voltage between the first and second power supply voltages into the reference gradation voltages.

13. The display control apparatus according to claim 11, wherein said white-display voltage control section is configured to optimize the white-display voltage with respect to the phase-transition threshold voltage.

14. The display control apparatus according to claim 13, wherein said white-display voltage is increased when the temperature of the liquid crystal display panel is higher than a predetermined room temperature range.

15. The display control apparatus according to claim 13, wherein said white-display voltage is increased when the temperature of the liquid crystal display panel is lower than a predetermined room temperature range.

16. The display control apparatus according to claim 12, wherein said black-display voltage control section is configured to optimize the black-display voltage with respect to the temperature of said liquid crystal display panel.

17. The display control apparatus according to claim 12, wherein the first power supply voltage is supplied across the ladder resistor section to obtain a positive polarity black-display voltage and a negative polarity black-display voltage with respect to the center point of voltage division, and the second power supply voltage is supplied across a portion containing the center point of voltage division in the ladder resistor section to obtain a positive polarity white-display voltage and a negative polarity white-display voltage with respect to the center point of voltage division.
